(19) United States
(12) Patent Application Publication
(10) Pub. No.: US 2024/0371286 A1
(43) Pub. Date: Nov. 7, 2024

(54) METHODS AND SYSTEMS FOR A TRAINING FUSION SIMULATOR

(71) Applicant: Smarter Reality, LLC, Round Rock, TX (US)

(72) Inventor: Walter Franklin Coppersmith, III, Round Rock, TX (US)

(73) Assignee: Smarter Reality, LLC, Round Rock, TX (US)

(21) Appl. No.: 18/653,792

(22) Filed: May 2, 2024

Related U.S. Application Data
(60) Provisional application No. 63/500,166, filed on May 4, 2023.

(51) Int. Cl. G09B 5/02; G06F 3/01

(52) U.S. Cl. CPC G09B 5/02; G06F 3/015

(57) ABSTRACT

A method disclosed herein comprises providing a first user interface to display on a first computing device of a first user, where the first user interface presents a plurality of disparate training topics. Each training topic of the plurality of disparate training topics is associated with one or more learning objectives. The method further comprises generating, based on a selection of training topics, an interactive experience for a second user to assess an understanding by the second user of one or more learning objectives associated with the selection of training topics, where the interactive experience includes a virtual 3D environment and one or more AI-enabled characters. The method further comprises controlling visual content associated with the interactive experience being rendered on a display of a second computing device of the second user by rendering a representation of the virtual 3D environment and the one or more AI-enabled characters.

### CROSS-REFERENCE TO RELATED APPLICATIONS

The present application claims the benefit of U.S. Provisional Application No. 63/500,166, entitled “METHODS AND SYSTEMS FOR A TRAINING FUSION SIMULATOR,” filed May 4, 2023, the content of which is incorporated by reference herein in its entirety for all purposes.

### TECHNICAL FIELD

This disclosure relates to simulation technologies. More specifically, this disclosure relates to a system and method for a training fusion simulator.

### BACKGROUND

Computer-based training (CBT) courses can be formulaic, repetitive, staid, and fail to take advantage of engagement and learning mechanics in video games. Conventional CBTs reward students for mindlessly clicking through content rather than encouraging absorption of content through the application of content within a real-world context. For example, younger students, who grow up playing immersive video games, are unimpressed by and uninterested in CBTs. CBTs can have a single, narrow training focus-such as avoiding enemy intelligence agents—and present students with no opportunity to apply their learnings to “real-world” events. Additionally, CBTs rarely build on one another; that is, lessons from one CBT typically do not transfer over to a subsequent CBT.

### SUMMARY

Representative embodiments set forth herein disclose various techniques for implementing a training fusion simulator.

In one embodiment, a method for using simulations for training is disclosed. The method includes providing a first user interface to display on a first computing device of a first user, where the first user interface presents a plurality of disparate training topics. Each training topic of the plurality of disparate training topics is associated with one or more learning objectives. The method further includes receiving, from the first computing device, a selection of training topics from the plurality of disparate training topics, and generating, based on the selection of training topics, an interactive experience for a second user to assess an understanding by the second user of one or more learning objectives associated with the selection of training topics. The interactive experience includes a virtual three-dimensional (3D) environment and one or more artificial intelligence (AI)-enabled characters. The method further includes controlling visual content associated with the interactive experience being rendered on a display of a second computing device of the second user by rendering a representation of the virtual 3D environment and the one or more AI-enabled characters.

In some embodiments, a tangible, non-transitory computer-readable medium stores instructions that, when executed, cause a processing device to perform any of the methods disclosed herein.

In some embodiments, a system includes a memory device storing instructions and a processing device communicatively coupled to the memory device. The processing device executes the instructions to perform any of the methods disclosed herein.

Other technical features may be readily apparent to one skilled in the art from the following figures, descriptions, and claims.

### BRIEF DESCRIPTION OF THE DRAWINGS

For a detailed description of example embodiments, reference will now be made to the accompanying drawings in which:

FIG. 1 illustrates a high-level component diagram of an illustrative system architecture, according to certain embodiments of this disclosure;

FIG. 2 illustrates an example user interface for a starting screen of the training fusion simulator, according to certain embodiments of this disclosure;

FIG. 3 illustrates an example user interface for an interactive experience screen, according to certain embodiments of this disclosure;

FIG. 4 illustrates an example user interface for an interactive experience screen, according to certain embodiments of this disclosure;

FIG. 5 illustrates an example user interface for assessing user choices and outcomes, according to certain embodiments of this disclosure;

FIG. 6 illustrates example operations of a method for using simulations for training with a computing device, according to certain embodiments of this disclosure;

FIG. 7 illustrates example operations of a method for using simulations for training with a computing device, according to certain embodiments of this disclosure;

FIG. 8 illustrates a high-level component diagram of an illustrative system architecture, according to certain embodiments of this disclosure;

FIG. 9 illustrates an example user interface for an interactive experience screen, according to certain embodiments of this disclosure;

FIG. 10 illustrates an example user interface for an interactive experience screen, according to certain embodiments of this disclosure;

FIG. 11 illustrates an example user interface for an interactive experience screen, according to certain embodiments of this disclosure;

FIG. 12 illustrates an example user interface for an interactive experience screen, according to certain embodiments of this disclosure;

FIG. 13 illustrates an example user interface for an interactive experience screen, according to certain embodiments of this disclosure;

FIG. 14 illustrates an example user interface for an interactive experience screen, according to certain embodiments of this disclosure;

FIG. 15 illustrates an example user interface for an interactive experience screen, according to certain embodiments of this disclosure;

FIG. 16 illustrates an example user interface for an interactive experience screen, according to certain embodiments of this disclosure;

FIG. 17 illustrates an example user interface for an interactive experience screen, according to certain embodiments of this disclosure;

FIG. 18 illustrates an example user interface for an interactive experience screen, according to certain embodiments of this disclosure; and

FIG. 19 illustrates an example computer system that can be configured to implement the embodiments of this disclosure.

### NOTATION AND NOMENCLATURE

Various terms are used to refer to particular system components. Different entities may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), solid state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### DETAILED DESCRIPTION

Embodiments described herein are directed to a training fusion simulator (“simulator”). The simulator may include a software-as-a-service 3D interactive training environment that brings together learning objectives of multiple, unrelated computer-based training (CBT) courses into a single interactive and immersive experience. Conventional CBTs can be formulaic, repetitive, staid, and fail to take advantage of engagement and learning mechanics in video games. Conventional CBTs reward students for mindlessly clicking through content rather than encouraging absorption of content through application of content within a real-world context. For example, younger students, who grow up playing immersive video games, are unimpressed by and uninterested in CBTs. CBTs can have a single, narrow training focus-such as avoiding enemy intelligence agents—and present students with no opportunity to apply their learnings to “real-world” events. Additionally, CBTs rarely build on one another; that is, lessons from one CBT do not transfer over to a subsequent CBT. As result, students often sit through many hours of unproductive training time with no measurable improvements in performance. The impact is that students do not retain important lessons and may not recognize situations that present ethical, legal, moral, or safety concerns.

To help address the foregoing issues, the simulator disclosed herein enables students to practice multiple, disparate training topics in a virtual environment that replicates the real-world and provides “just in time” training to address emerging threats (e.g., intelligence collection). Some of these training topics may include: antiterrorism, counterintelligence, human trafficking, equal opportunity, information assurance, security, sexual assault prevention and response, sexual harassment, substance abuse, legal misconduct, and suicide prevention. Additionally, the simulator provides feedback on student choices to improve decision-making, and increases student situational awareness for improved “issue spotting” via scenarios that test the disparate training topics simultaneously. The simulator empowers students to face true-to-life situations, make consequential decisions, and receive timely feedback from a personal computer or individual mobile device.

The simulator improves the effectiveness of CBT through the use of artificial intelligence (AI)-enabled simulation technology that empowers students to apply lessons learned in CBTs across a range of disciplines in interactive and immersive scenarios presented in a simulated, realistic 3D virtual environment. For example, in some embodiments, the student may start the simulator on a computer or mobile device by selecting from among multiple scenario options depending on their learning objective. The student may begin interacting with the virtual 3D environment, moving from location to location, and communicating with AI-enabled non-player characters to satisfy scenario success conditions. In one scenario, the student may be tasked to move through a crowded area, where AI-enabled characters and scenario-driven events take place to which the student must respond. For example, in one particular scenario, a “friendly” stranger encountered outside a hotel in the virtual 3D environment could be an innocent tourist, a foreign intelligence agent, or a mugger. The student may make choices on how to respond to the stranger. After the scenario ends, the student can review their choices and review relevant CBT materials. The student can then either progress to later scenarios (in the narrative), replay the experience to explore different choices and the results that follow, and so on.

More specifically, the simulator provides scenarios or interactive experiences that combine learning from multiple CBTs (e.g., threat awareness, counter-intelligence, sexual assault prevention and response, etc.). During a training scenario, a student must evaluate events from multiple perspectives, such as if a person is being trafficked or the person is involved in a “honey trap.” Embodiments may include a 3D interactive virtual environment of various settings such as a city street with relevant locations (e.g., restaurant, hotel, etc.). Each interactive scenario may blend learning objectives across multiple training disciplines. Further, an expert system AI allows the simulation to react to student choices in a repeatable and transparent manner. For example, the interactive environment may allow different participant choices to lead to different outcomes, as well as allow for replay of these choices and selection of different choices within the same interactive environment. In accordance with embodiments described herein, the simulator encourages customization. For example, scenario, environment, and non-player character behavior can be adjusted to suit training needs. The simulator also allows for user-friendly scenario customization to thereby empower instructors to focus training on students' needs. Additionally, participants can “play, fail fast, and learn” to experiment with different approaches and options without the inherent risks that otherwise accompany real-life scenarios. Students and instructors can then review choices after the scenario ends. Data can be collected across different users and scenarios to evaluate CBT effectiveness and information retention.

Accordingly, the simulator provides high quality training by providing a dynamic, engaging, and interactive learning environment with clear learning objectives. Further, the simulator provides immediate application of learned content to real-world contexts and scenarios with relevance to students. The simulator includes context-appropriate interactive systems that support the navigation of 3D environments, sophisticated analytics, user administration, and scenario customization. Additionally, the simulator's virtual environment may provide an experience in which students may practice what they are learning in a contextually-relevant scenario that drives retention and engagement.

The embodiments are described herein with reference to military training. However, it should be noted that civilian training topics are also included within the scope of this disclosure. Additionally, it should be appreciated that the embodiments described herein are adaptable and customizable to support the training needs of any profession. For example, many professions, such as police officers, security guards, teachers, managers, and the like, may benefit from the use of the simulator for training.

In some embodiments, the present disclosure provides various technical solutions to technical problems. The technical problems may include providing virtual simulations of scenarios based on user inputs (e.g., speech, gesture, vital signs, etc.) and real-time control of the AI-enabled characters in response to the user input. The technical solution may include (1) receiving the user input via one or more input peripherals (e.g., microphone, vibration sensor, pressure sensor, camera, etc.), (2) using speech-to-text conversion and natural language processing techniques to transform the speech to text, and (3) using one or more machine learning models trained receive the text as input and to output a meaning of the text. The meaning of the text may be used by an expert AI system to determine one or more reactions to meaning, and the one or more reactions may be used to control the AI enabled characters presented digitally within a user interface that is output by way of a display screen that is communicatively coupled to a computing device. Such techniques may provide technical benefits of dynamically adjusting reactions of an AI-enabled character within a computing device in real-time based on user input (e.g., audible spoken words transformed into text that is interpreted via natural language processing).

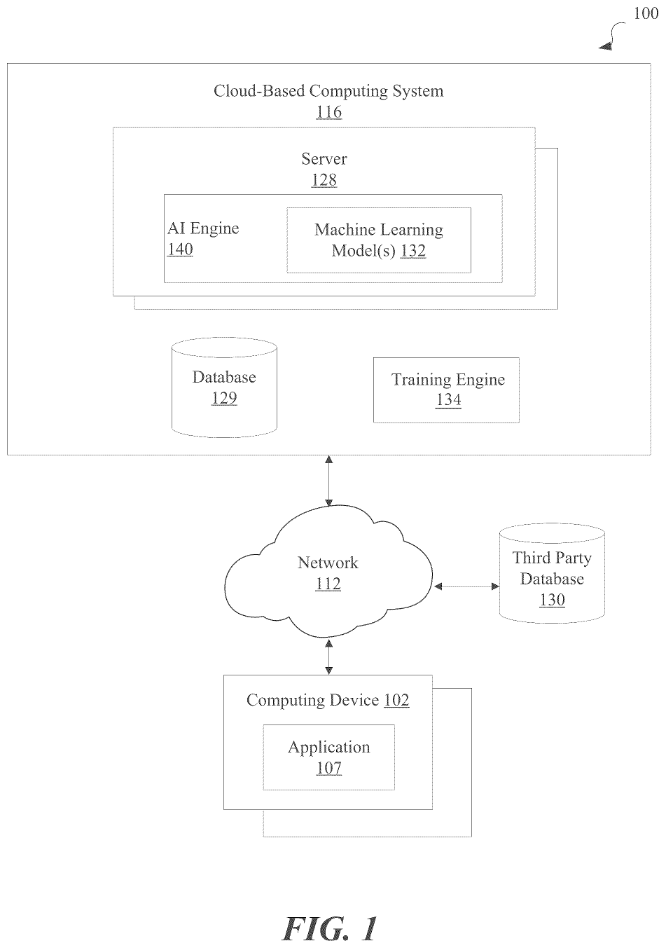

To explore the foregoing in more detail, FIG. 1 will now be described. FIG. 1 illustrates a high-level component diagram of an illustrative system architecture 100, according to certain embodiments of this disclosure. In some embodiments, the system architecture 100 may include computing devices 102, a cloud-based computing system 116, and/or a third-party database 130 that are communicatively coupled via a network 112. As used herein, a cloud-based computing system refers, without limitation, to any remote or distal computing system accessed over a network link. Each of the computing devices 102 may include one or more processing devices, memory devices, and network interface devices.

The network interface devices of the computing devices 102 may enable communication via a wireless protocol for transmitting data over short distances, such as Bluetooth, ZigBee, near field communication (NFC), etc. Additionally, the network interface devices may enable communicating data over long distances, and in one example, the computing devices 102 may communicate with the network 112. Network 112 may be a public network (e.g., connected to the Internet via wired (Ethernet) or wireless (WiFi)), a private network (e.g., a local area network (LAN), a wide area network (WAN), a virtual private network (VPN)), or a combination thereof.

The computing device 102 may be any suitable computing device, such as a laptop, tablet, smartphone, virtual reality device, augmented reality device, or the like. The computing device 102 may include a display that is capable of presenting a user interface of an application 107. As one example, the computing device 102 may be operated by cadets or faculty of a military academy. The application 107 may be implemented in computer instructions stored on a memory of the computing device 102 and executed by a processing device of the computing device 102. The application 107 may be a conflict resolution platform including an AI-enabled simulator, and may be a stand-alone application that is installed on the computing device 102 or may be an application (e.g., website) that executes via a web browser. The application 107 may present various screens, notifications, and/or messages to a user. As described herein, the screens, notifications, and/or messages may be associated with dialogue with an AI-enabled character on a training topic.

In some embodiments, the cloud-based computing system 116 may include one or more servers 128 that form a distributed, grid, and/or peer-to-peer (P2P) computing architecture. Each of the servers 128 may include one or more processing devices, memory devices, data storage, and/or network interface devices. The servers 128 may execute an AI engine 140 that uses one or more machine learning models 132 to perform at least one of the embodiments disclosed herein. The servers 128 may be in communication with one another via any suitable communication protocol. The servers 128 may enable configuring a scenario or interactive experience that combine learning from multiple CBTs or training topics for a user. For example, the training topics may be related to one or more of the following topics: antiterrorism, counterintelligence, human trafficking, equal opportunity, information assurance, security, sexual assault prevention and response, sexual harassment, substance abuse, legal misconduct, suicide prevention, etc. The servers 128 may provide user interfaces that are specific to a scenario. For example, a user interface provided to the user may include background information on the scenario. The servers 128 may execute the scenarios and may determine inputs and options available for subsequent turns based on selections made by users in previous turns. The servers 128 may provide messages to the computing devices 102 of the users participating in the scenario. The servers 128 may provide messages to the computing devices 102 of the users after the scenario is complete. Additionally, AI engine 140 may include the conflict resolution simulator. According to some embodiments, the conflict resolution simulator may comprise the following components: an adaptive conversation engine, a high-fidelity AI-enabled character, a user-friendly conversation creation tool, a conversation library (where user-generated and supplied content can be accessed, shared, and customized), and a post-conversation analytics system.

In some embodiments, the cloud-based computing system 116 may include a database 129. The cloud-based computing system 116 may also be connected to the third-party database 130. The databases 129 and/or 130 may store data pertaining to scenarios, users, results of the scenarios, and the like. The results may be stored for each user and may be tracked over time to determine whether a user is improving. Further, observations may include indications of which types of selections are successful in improving the success rate of a particular scenario. Completed scenarios including user selections taken and responses to the user selections for each turn in the scenarios may be saved for subsequent playback. For example, a user may review the saved completed scenario to determine what were the right and wrong user selections taken by the user during the scenario. The database 129 and/or 130 may store a library of scenarios that enable the users to select the scenarios and/or share the scenarios.

The computing system 116 may include a training engine 134 capable of generating one or more machine learning models 132. Although depicted separately from the AI engine 140, the training engine 134 may, in some embodiments, be included in the AI engine 140 executing on the server 128. In some embodiments, the AI engine 140 may use the training engine 134 to generate the machine learning models 132 trained to perform inferencing operations, predicting operations, determining operations, controlling operations, or the like. The machine learning models 132 may be trained to: (1) simulate a scenario based on user selections and responses, (2) dynamically update user interfaces for scenarios and specific turns based on one or more user selections (e.g., dialogue options or physical interactions) in previous turns, (3) dynamically update user interfaces by changing available information (e.g., dialogue or physical interactions), (4) select the responses, available information, and next state of the scenario in subsequent turns based on user selections and combination of user selections in previous turns, and/or (5) improve feature selection of the machine learning models 132 by scoring the results of the scenarios produced, among other things. The one or more machine learning models 132 may be generated by the training engine 134 and may be implemented in computer instructions executable by one or more processing devices of the training engine 134 or the servers 128.

The training engine 134 may be a rackmount server, a router, a personal computer, a portable digital assistant, a smartphone, a laptop computer, a tablet computer, a netbook, a desktop computer, an Internet of Things (IoT) device, any other desired computing device, or any combination of the above. The training engine 134 may be cloud-based, be a real-time software platform, include privacy software or protocols, or include security software or protocols.

To generate the one or more machine learning models 132, the training engine 134 may train the one or more machine learning models 132. The training engine 134 may use a base data set of user selections and scenario states and outputs pertaining to resulting states of the scenario based on the user selections. In some embodiments, the base data set may refer to training data, and the training data may include labels and rules that specify certain outputs are to occur when certain inputs are received. For example, if user selections are made in turn two (2), then certain responses/states of the scenario and user interfaces are to be provided in turn three (3).

The one or more machine learning models 132 may refer to model artifacts created by the training engine 134 using training data that includes training inputs and corresponding target outputs. The training engine 134 may find patterns in the training data—where such patterns map the training input to the target output—and generate machine learning models 132 that capture these patterns. Although depicted separately from the server 128, in some embodiments, the training engine 134 may reside on server 128. Further, in some embodiments, the artificial intelligence engine 140, the database 129, or the training engine 134 may reside on the computing device 102.

As described herein, the one or more machine learning models 132 may comprise, e.g., a single level of linear or non-linear operations (e.g., a support vector machine (SVM)), or the machine learning models 132 may be a deep network (i.e., a machine learning model comprising multiple levels of non-linear operations). Examples of deep networks are neural networks, including generative adversarial networks, convolutional neural networks, recurrent neural networks with one or more hidden layers, and fully connected neural networks (e.g., where each artificial neuron may transmit its output signal to the input of the remaining neurons, as well as to itself). For example, the machine learning model may include numerous layers or hidden layers that perform calculations (e.g., dot products) using various neurons.

In some embodiments, one or more of the machine learning models 132 may be trained to use causal inference and counterfactuals. For example, the machine learning model 132 trained to use causal inference may accept one or more inputs, such as (i) assumptions, (ii) queries, and (iii) data. The machine learning model 132 may be trained to output one or more outputs, such as (i) a decision as to whether a query may be answered, (ii) an objective function (also referred to as an estimand) that provides an answer to the query for any received data, and (iii) an estimated answer to the query and an estimated uncertainty of the answer, where the estimated answer is based on the data and the objective function, and the estimated uncertainty reflects the quality of data (i.e., a measure that takes into account the degree or salience of incorrect data or missing data). The assumptions may also be referred to as constraints, and may be simplified into statements used in the machine learning model 132. The queries may refer to scientific questions for which the answers are desired.

The answers estimated using causal inference by the machine learning model may include optimized scenarios that enable more efficient training of military personnel. As the machine learning model estimates answers (e.g., scenario outcomes based on alternative action selection), certain causal diagrams may be generated, as well as logical statements, and patterns may be detected. For example, one pattern may indicate that “there is no path connecting ingredient D and activity P,” which may translate to a statistical statement “D and P are independent.” If alternative calculations using counterfactuals contradict or do not support that statistical statement, then the machine learning model 132 may be updated. For example, another machine learning model 132 may be used to compute a degree of fitness that represents a degree to which the data is compatible with the assumptions used by the machine learning model that uses causal inference. There are certain techniques that may be employed by the other machine learning model 132 to reduce the uncertainty and to increase the degree of compatibility. The techniques may include those for maximum likelihood, propensity scores, confidence indicators, or significance tests, among others.

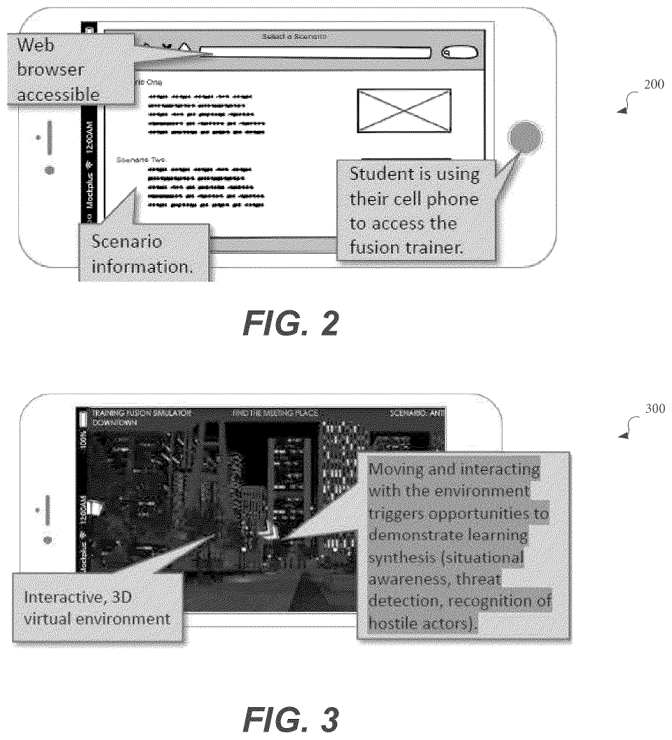

FIG. 2 illustrates an example user interface 200 for a starting screen of the simulator, according to certain embodiments of this disclosure. The user interface 200 presents a scenario selection screen. The user interface 200 also includes various graphical elements (e.g., buttons) for different scenarios. For example, the user may select from among multiple scenario options depending on their learning objective. As shown in FIG. 2, the user interface 200 may also display background information on the scenario. The background information may include a description of the scenario. The user interface 200 may be presented when a user logs into the simulator with their credentials. The selection of the scenario may be transmitted to the cloud-based computing system 116.

In some embodiments, an instructor interface may be displayed on a computing device of an instructor. The instructor interface may present a plurality of disparate training topics and each training topic of the plurality of disparate training topics may be associated with one or more learning objectives. The instructor may select a scenario based on the learning objectives. The scenario may test learning objectives associated with two or more of the following training topics: antiterrorism, counterintelligence, human trafficking, equal opportunity, information assurance, security, sexual assault prevention and response, sexual harassment, substance abuse, legal misconduct, suicide prevention, and so on.

In some embodiments, a user interface may present a student with a 3D, virtual environment (e.g., a city street with relevant locations such as a hotel and restaurant) where students can use game interaction mechanics to explore the environment, speak to AI-enabled non-player characters, and interact with the mission and story. For example, FIG. 3 illustrates an exemplary embodiment of a user interface of the simulator, according to certain embodiments of this disclosure. In FIG. 3, user interface 300 represents a scenario or interactive experience relating to “antiterrorism,” and learning objectives associated with the scenario may be displayed.

The scenario may progress by the student accomplishing one or more missions or goals. For example, as further depicted in FIG. 3, the student may be prompted to “find the meeting place.” During a scenario, a simple mission could be to walk from a hotel to a restaurant where an avatar of the student is meeting friends. Along the way, the avatar will encounter a friendly person who wants to talk. This virtual conversation can have a range of potential legal or safety implications. The individual could be a friendly tourist, who is happy to see another American in an unfamiliar place or could be a foreign intelligence agent gathering intelligence. Or, more dangerously, the person could attempt to threaten the student. These experiences cover a range of CBT training content and enable the student to practice the content in a real-world setting. These simulated events are highly memorable and replace rote learning with experiences that have an impact on the student. The simulator adapts video game mechanics to drive student engagement with the experience and retention of the material.

Additionally, FIG. 3 illustrates user interface 300 of the simulator executing on a mobile device, according to certain embodiments of this disclosure. As depicted, various graphical elements may be used to display information and simultaneously prompt a user to select different options during a turn of the scenario presented on the user interface 300. The various graphical elements may enable relevant information to be presented in a manner that does not inundate the small screen of the mobile device. Accordingly, the user interface 300 provides an enhanced experience for users using the simulator.

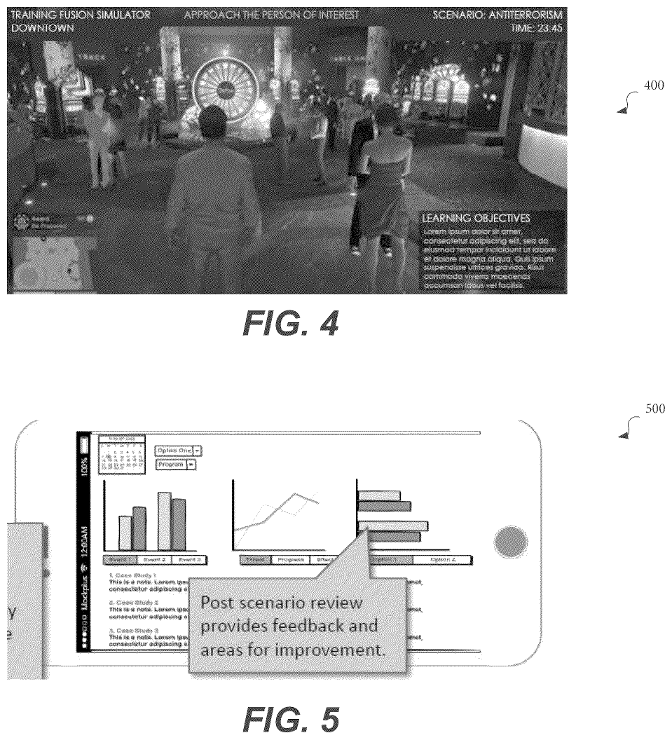

FIG. 4 illustrates an exemplary embodiment of a user interface of the simulator, according to certain embodiments of this disclosure. In FIG. 4, user interface 400 represents a scenario or interactive experience relating to “antiterrorism,” and a student is instructed to “approach the person of interest.” During the scenario, the student may be represented by a customizable avatar. The student may interact and “speak” with AI-enabled characters, which may trigger events. In some instances, the events may be innocuous, while others may be dangerous. Moving and interacting with the environment triggers opportunities to demonstrate learning synthesis (situational awareness, threat detection, recognition of hostile actors, etc.).

In some embodiments, the AI-enabled character may respond based on the user's attitude (e.g., accusatory, friendly, angry, etc.) and conversational choices. Further, the AI-enabled character's programmed characteristics and scenario background can influence the AI-enabled character's behavior and the course of the virtual conversation. As further shown in FIG. 4, the AI-enabled character may also display different behavioral cues (e.g., nervous, afraid, threatened, etc.). In some embodiments, the AI-enabled character may include adjustable “behavioral” elements so that users face a range of emotional responses (e.g., angry, sullen, quiet, etc.). The cloud-based computing system 116 may receive the user's selections and the AI engine 140 may begin the simulation of the scenario with customized user interfaces for each user selection and each turn, where the user interfaces are dynamically modified in subsequent turns based on the user selections in previous turns.

FIG. 5 illustrates an example user interface 500 for reviewing a user's selections, according to certain embodiments of this disclosure. For example, once the scenario is complete, the user can review their choices, and then play the scenario again to explore how different choices can lead to different outcomes. In some embodiments, as the student makes different selections, the simulator moves through a set of decision-trees and presents the student with new information related to the training topic. Some user interactions may be more appropriate. In some embodiments, the user may play back the scenario and review selections made by the user during the scenario. In some embodiments, user interface 500 may provide feedback and areas for improvement (e.g., interactions that would have allowed for a safer outcome, a more favorable outcome, etc.).

In some embodiments, user interface 500 may compare student choices and outcomes with other users, according to certain embodiments of this disclosure. For example, users can compare choices and outcomes with other users anonymously to understand shared values within a community. The user interface may display graphical representations of the performance of a scenario of the user and other users. In some embodiments, each user selection may be scored.

The user interfaces described herein may be presented in real-time or near real-time. The selections made by the user using graphical elements of the user interfaces may be used by the AI engine 140 to determine the state of the scenario in the next turn and to generate the user interfaces that are presented for each turn of in the scenario. It should be appreciated that different users may concurrently participate in different scenarios at the same time using the simulator.

By providing graphical representations of a user's performance in a scenario, the user can quickly evaluate their performance and determine if they need additional training in a topic. Providing graphical representations for the scenario enables the user to make a decision quickly without having to drill-down and view each turn of the scenario in detail. Accordingly, the user interface 500 provides an enhanced experience for users using the simulator.

In some embodiments, a user interface for enabling an instructor to modify or create scenarios may be provided to a computing device of the instructor, according to certain embodiments of this disclosure. The user interface is associated with a scenario creator tool. To ensure lasting relevance, the simulator may include a scenario builder shown in the user interface. The scenario builder enables a user or evaluator/instructor to create scenarios and share the scenario with others. A user may use the scenario creator tool for creating dialogue options or goals for a student to accomplish for each turn in a scenario and assigning scores to each user choice. Further, the instructor may also adjust attributes (e.g., attitudes, goals, mannerisms, etc.) of AI-enabled characters.

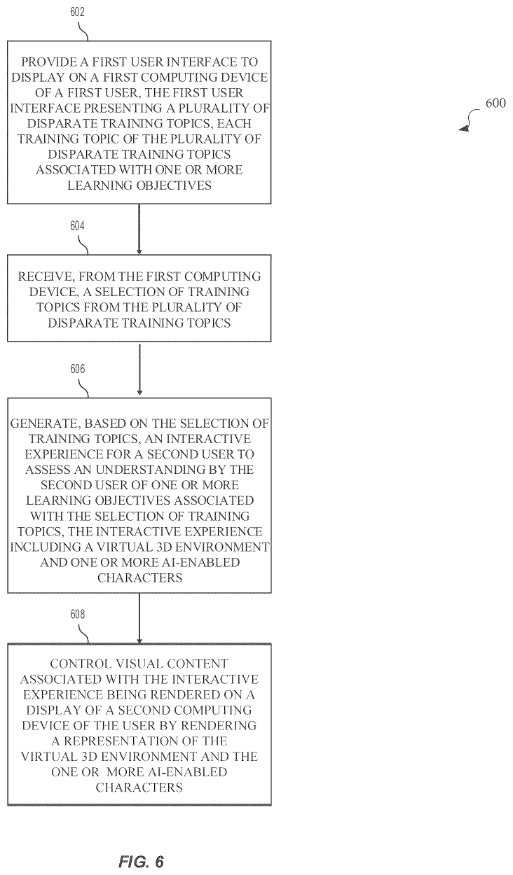

FIG. 6 illustrates example operations of a method 600 for using simulations for training, according to certain embodiments of this disclosure. The method 600 may be performed by processing logic that may include hardware (circuitry, dedicated logic, etc.), software, or a combination of both. The method 600 and/or each of their individual functions, subroutines, or operations may be performed by one or more processors of a computing device (e.g., any component (server 128, etc.) of cloud-based computing system 116, or the computing device 102, of FIG. 1) implementing the method 600. The method 600 may be implemented as computer instructions stored on a memory device and executable by the one or more processors. In certain implementations, the method 600 may be performed by a single processing thread. Alternatively, the method 600 may be performed by two or more processing threads, where each thread implements one or more individual functions, routines, subroutines, or operations of the methods.

At block 602, the processing device may provide a first user interface to display on a first computing device of a first user, where the first user interface presents a plurality of disparate training topics. Each training topic of the plurality of disparate training topics are associated with one or more learning objectives. The computing device may include desktop computers, laptop computers, mobile devices (e.g., smartphones), tablet computers, etc. The user interface may present a plurality of training topics to an instructor and each training topic of the plurality of disparate training topics may be associated with one or more learning objectives. For example, an antiterrorism training topic may include the learning objectives of identifying a terrorist threat and demonstrating knowledge of measures to reduce personal vulnerability to terrorism. As another example, a human trafficking training topic may include the following learning objectives of identifying victims of human trafficking, how to interact with a potential victim of human trafficking, and actions to take after identifying a potential case of human trafficking.

At block 604, the processing device may receive, from the first computing device, a selection of training topics from the plurality of disparate training topics. In some embodiments, the selection may include at least two training topics. For example, the selection from the instructor may include at least two of the following training topics: antiterrorism, counterintelligence, human trafficking, equal opportunity, information assurance, security, sexual assault prevention and response, sexual harassment, substance abuse, legal misconduct, suicide prevention, and the like.

At block 606, the processing device may generate, based on the selection of training topics, an interactive experience for a second user to assess an understanding by the second user of one or more learning objectives associated with the selection of training topics. The interactive experience may include a virtual 3D environment and one or more AI-enabled characters. For example, the interactive experience or scenario may be generated to assess a student's understanding of security and human trafficking training topics.

At block 608, the processing device may control visual content associated with the interactive experience being rendered on a display of a second computing device of the second user by rendering a representation of the virtual 3D environment and the one or more AI-enabled characters. For example, in a particular scenario, training topics related to security and human trafficking may be implemented. That scenario may include an encounter with a female AI-enabled character at a downtown lounge. Based on the 3D virtual environment and interactions with the AI-enabled character, the student may try to determine if she is a foreign intelligence agent or a trafficking victim. In some embodiments, the student will navigate the scenario through a first-person self-avatar and be requested to accomplish one or more objectives (e.g., order a drink at the bar). In this scenario, the female AI-enabled character may approach the student's avatar and ask if the student is American. The student then determines how to react to the female AI-enabled character (e.g., by selecting an interaction from a selection wheel). By the simulator implementing an interactive 3D environment, the students can better perceive and investigate their environments and incorporate these details into their analyses to determine how best to interact with AI-enabled characters.

In some embodiments, based on student's interaction selection, the processing device may modify, using the AI engine 140, the scenario for a subsequent turn to cause a reaction from the AI-enabled character to be transmitted to the computing device. In some embodiments, the processing device may generate, via the AI engine 140, one or more machine learning models 132 trained to modify the scenario for the subsequent turn to cause a reaction from the AI-enabled character to be transmitted to the computing device.

In some embodiments, assessing a user's understanding of one or more learning objectives associated with a training topic may include associating each user's interaction with the interactive environment being scored. For example, each user interaction may be associated with a score. The value of the score may represent a comparison among each interaction relative to each other as a better or a poorer user selection. For example, during a scenario, a phone of student's avatar may be stolen. The student selection of chasing a perpetrator running away with the phone may be scored lower than the student selection of reporting the phone stolen so that sensitive information can be remotely removed from the phone. In some embodiments, based on the user's score from completing a scenario, it can be determined if the user has attained a satisfactory understanding of one or more learning objectives associated with a training topic. This can be determined if the score is above a threshold amount.

In some embodiments, a computing device of an instructor may be provided a user interface to display, where the user interface presents the one or more learning objectives associated with a training topic and corresponding scores indicating a proficiency of understanding of a student. In some embodiments, in response to determining that a student has not attained a satisfactory understanding of the one or more learning objectives associated with the selection of training topics, a second user interface is provided to a first computing device, where the user interface enables the instructor to adapt the interactive experience to further-assess the understanding by the student of the one or more learning objectives associated with a training topic. Still yet, in some embodiments, in response to determining that the student has not attained the satisfactory understanding of the one or more learning objectives associated with a training topic, a user interface is provided to display on a computing device. According to some embodiments, the user interface can indicate interactions of the student with the virtual 3D environment (and/or the one or more AI-enabled characters) that exhibited that the student has not attained the satisfactory understanding, as well as alternative interactions that the student could have had with the virtual 3D environment (and/or the one or more AI-enabled characters) that would have better indicated the understanding of the one or more learning objectives associated with the training topic.

In some embodiments, the processing device may receive, from a sensor, one or more measurements pertaining to the user (e.g., heart rate), where the one or more measurements are received during the scenario, and the one or more measurements may indicate a characteristic of the user (e.g., an elevated heart rate may indicate that the user is stressed). The sensor may be a wearable device, such as a watch, a necklace, an anklet, a ring, a belt, etc. The sensor may include one or more devices for measuring any suitable characteristics of the user. Further, based on the characteristic, the processing device may modify, using the AI engine 140, the scenario for the subsequent turn (e.g., by avoiding combative dialogue). For example, the characteristics may comprise any of the following: a vital sign, a physiological state, a heartrate, a blood pressure, a pulse, a temperature, a perspiration rate, or some combination thereof. The sensor may include a wearable device, a camera, a device located proximate the user, a device included in the computing device, or some combination thereof.

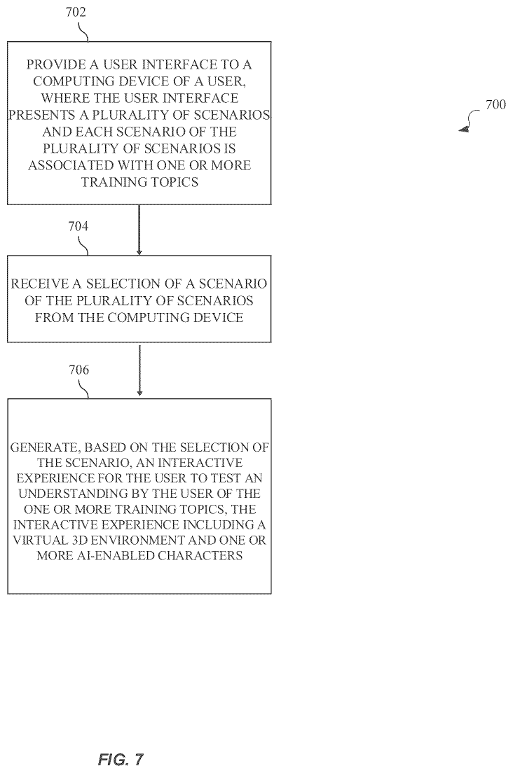

FIG. 7 illustrates example operations of a method 700 for using simulations for training, according to certain embodiments of this disclosure. The method 700 may be performed by processing logic that may include hardware (circuitry, dedicated logic, etc.), software, or a combination of both. The method 700 and/or each of their individual functions, subroutines, or operations may be performed by one or more processors of a computing device (e.g., any component (server 128, etc.) of cloud-based computing system 116, or the computing device 102, of FIG. 1) implementing the method 700. The method 700 may be implemented as computer instructions stored on a memory device and executable by the one or more processors. In certain implementations, the method 700 may be performed by a single processing thread. Alternatively, the method 700 may be performed by two or more processing threads, each thread implementing one or more individual functions, routines, subroutines, or operations of the methods.

At block 702, the processing device may provide a user interface to a computing device of a user, where the user interface presents a plurality of scenarios, and each scenario of the plurality of scenarios is associated with one or more training topics. The computing device may include desktop computers, laptop computers, mobile devices (e.g., smartphones), tablet computers, etc.

At block 704, the processing device may receive a selection of a scenario of the plurality of scenarios from the computing device. For example, the selection of the scenario may be made by a student.

At block 706, the processing device may generate, based on the selection of the scenario, an interactive experience for the user to test an understanding by the user of the one or more training topics, where the interactive experience includes a virtual 3D environment and one or more AI-enabled characters. For example, the interactive experience or scenario may be generated to assess a student's understanding of security and human trafficking training topics.

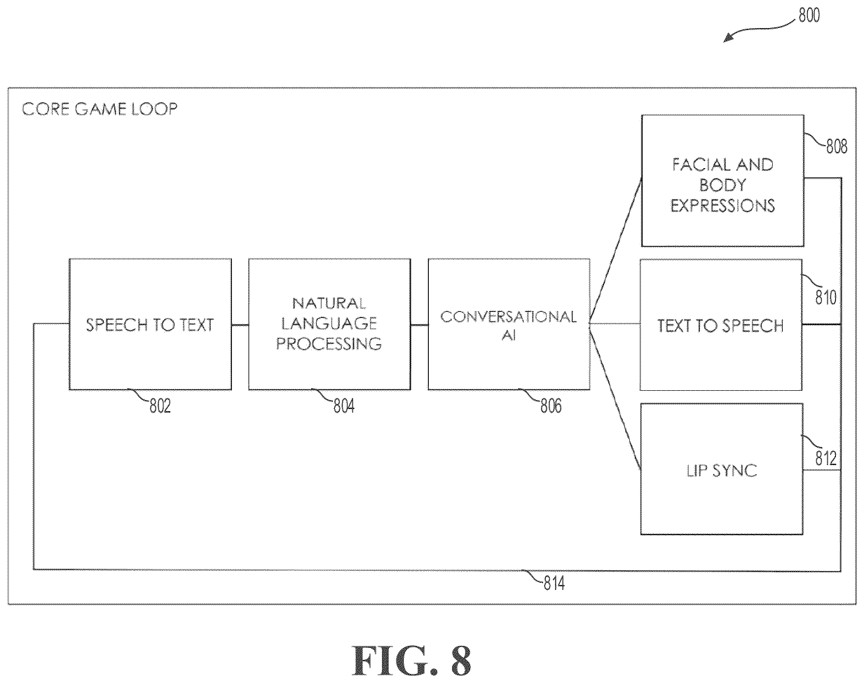

To explore the foregoing in more detail, FIG. 8 will now be described. FIG. 8 illustrates a high-level component diagram of an illustrative system architecture, according to certain embodiments of this disclosure. FIG. 8 provides another exemplary embodiment of cloud-based computing system 116 in FIG. 1. As shown in FIG. 8, simulator 800 may include: a speech to text component 802 that is configured to record, analyze, and translate a user's voice input into text format; a natural language processing component 804 configured to analyze the user's input to generate a natural language understanding result; a conversational AI-enabled character 806 configured to respond to the user's input; a facial and body expressions component 808 configured to determine AI-enabled character 806 reactions to the user's voice input (e.g., based on a user's action and graphical representation of mood); a text to speech component 810 configured to transform responses of the AI-enabled character into verbal replies; a lip synchronization component 812 configured to synchronize the visual representation of a mouth of the AI-enabled character 806 to verbal responses; and a core came loop 814 that comprises multiple scenarios and branching narratives based on the response of the AI-enabled character 806 to the user's input. Alternatively, or in addition, simulator 800 may respond to a user's input in text or prerecorded responses.

In some embodiments, speech to text component 802 may receive speech audio data from a virtual reality device (e.g., computing device 102 in FIG. 1), process the speech audio data, and provide the text equivalent to natural language processing component 804. Speech to text component 802 may use one or more speech to text techniques to process the speech audio data. For example, models in speech recognition may be divided into an acoustic model and a language model. The acoustic model may solve the problem of turning sound signals into some kind of phonetic representation. The language model may house the domain knowledge of words, grammar, and sentence structure for the language. These conceptual models can be implemented with probabilistic models (e.g., Hidden Markov models, Deep Neural Network models, etc.) using machine learning algorithms.

Further, natural language processing component 804 may use natural language processing (NLP), data mining, and pattern recognition technologies to process the text equivalent to generate a natural language understanding result. More specifically, natural language processing component 804 may use different AI technologies to understand language, translate content between languages, recognize elements in speech, and perform sentiment analysis. For example, natural language processing component 804 may use NLP and data mining and pattern recognition technologies to collect and process information provided in different information resources. Additionally, natural language processing component 804 may use natural language understanding (NLU) techniques to process unstructured data using text analytics to extract entities, relationships, keywords, semantic roles, and so forth. Natural language processing component 804 may generate the natural language understanding result to help AI engine 140 to understand the user's voice input. AI engine 140 may determine, based on the natural language understanding result, a response to the user's verbal input. In addition, using facial and body expressions component 808, text to speech component 810, and lip synchronization component 812, AI engine 140 may control visual content associated with the scenario being rendered on the display of the virtual reality device by rendering a representation of the AI-enabled character enacting a natural language response to the user's verbal input.

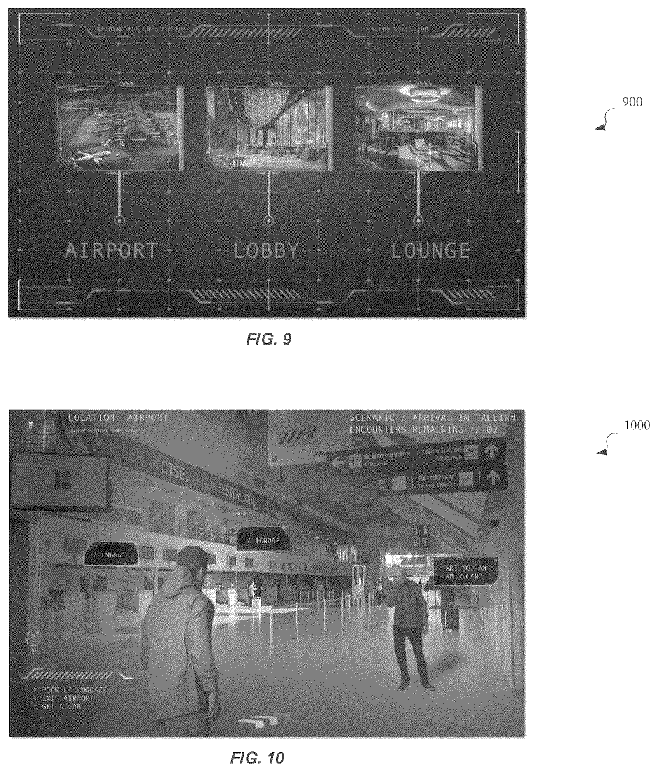

FIGS. 9-18 illustrate example user interfaces of the simulator, according to certain embodiments of this disclosure. FIG. 9 illustrates an example user interface 900 for a starting screen of the training fusion simulator, according to certain embodiments of this disclosure. The user interface 900 presents a scene selection screen that displays multiple scenes (e.g., airport, lobby, lounge, etc.). In some embodiments, the student may start the simulation by selecting a scene. The selection of the scene may be transmitted to the cloud-based computing system 116.

FIG. 10 illustrates an example user interface 1000 for a scenario or interactive experience for a student, according to certain embodiments of this disclosure. As depicted in FIG. 10, the user interface 1000 presents a scenario related to “Arrival in Tallinn” at an airport. The student is instructed to complete the following goals: pick-up their luggage, exit the airport, and get a car. In the process of completing these goals, the student will encounter AI-enabled characters. As further depicted in FIG. 10, the student encounters an AI-enabled character who asks, “Are you an American?” The student can either select to engage with or ignore the AI-enabled character.

In some embodiments, the student may interact with one or more AI-enabled characters. During the simulation, the AI-enabled characters may respond to the student's verbal and non-verbal input. The interactive environment allows users to view and interact with the AI-enabled characters (e.g., by viewing, understanding, and responding to signs of agitation or distress). Through the user interface 1000, the user may observe behavioral cues of the AI-enabled characters and the 3D virtual environment (e.g., location). The AI-enabled characters may also display different behavioral cues (e.g., nervous, afraid, threatening, friendly, etc.), and the interaction may take place in different locations (e.g., airport, night club, sports field, etc.). Further, in some embodiments, the AI-enabled characters may respond based on the student's behavior (e.g., accusatory, friendly, angry, etc.) and interaction choices. In some embodiments, the AI-enabled characters' programmed characteristics and scenario background may influence the AI-enabled characters' behavior and the course of the virtual interaction.

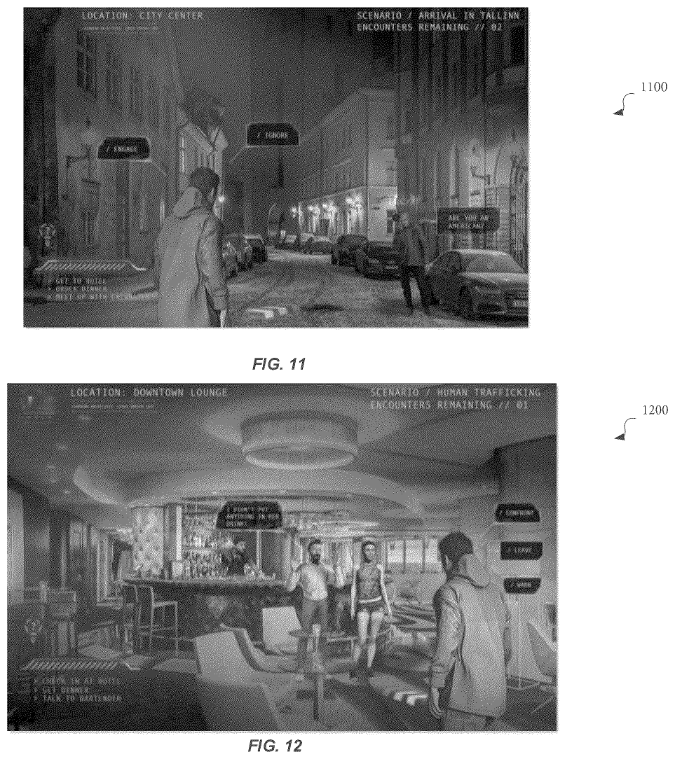

FIG. 11 illustrates another example user interface 1100 for a scenario or interactive experience for a student, according to certain embodiments of this disclosure. As depicted in FIG. 11, the user interface 1100 presents a scenario related to “Arrival in Tallinn” at a city center. The student is instructed to complete the following goals: get to a hotel, order dinner, and meet up with crewmates. As further depicted in FIG. 11, the student encounters an AI-enabled character who asks, “Are you an American?” The student can either select to engage with or ignore the AI-enabled character.

FIG. 12 illustrates another example user interface 1200 for a scenario or interactive experience for a student, according to certain embodiments of this disclosure. As depicted in FIG. 12, the user interface 1200 presents a scenario related to “Human Trafficking” at a downtown lounge. The student is instructed to complete the following goals: check-in at a hotel, get dinner, and talk to a bartender. In the process of completing these goals, the student will encounter AI-enabled characters. As further depicted in FIG. 12, the student encounters an AI-enabled character who responds, “I didn't put anything in her drink!” The student can either select to engage with the AI-enabled character by confronting the AI-enabled character, leaving the bar, or warning others about the ordeal.

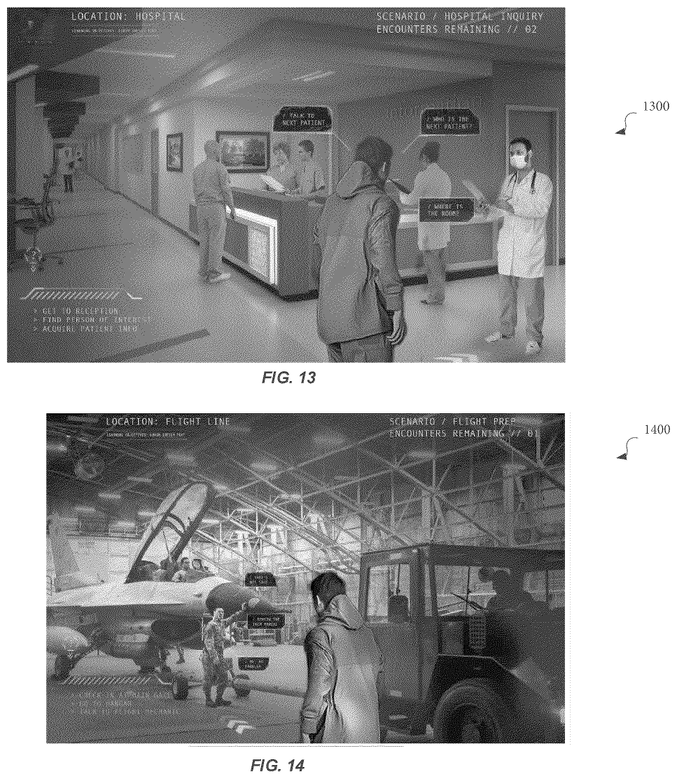

FIG. 13 illustrates another example user interface 1300 for a scenario or interactive experience for a student, according to certain embodiments of this disclosure. As depicted in FIG. 13, the user interface 1300 presents a scenario related to “Hospital Inquiry” at a hospital. The student is instructed to complete the following goals: get to the reception area of the hospital, find a person of interest, and acquire patient information. As further depicted in FIG. 13, the student encounters an AI-enabled character who works at the hospital. The student can either select to talk to the next patient, ask who the next patient is, or ask where a room is located.

FIG. 14 illustrates another example user interface 1400 for a scenario or interactive experience for a student, according to certain embodiments of this disclosure. As depicted in FIG. 14, the user interface 1400 presents a scenario related to “Flight Prep” at a flight line. The student is instructed to complete the following goals: check-in at a main gate, go to a hanger, and talk to a flight mechanic. As further depicted in FIG. 14, the student encounters an AI-enabled character who is a flight mechanic. The student can either select to warn of an unsafe situation, review a tech manual, or indicate that a situation is safe.

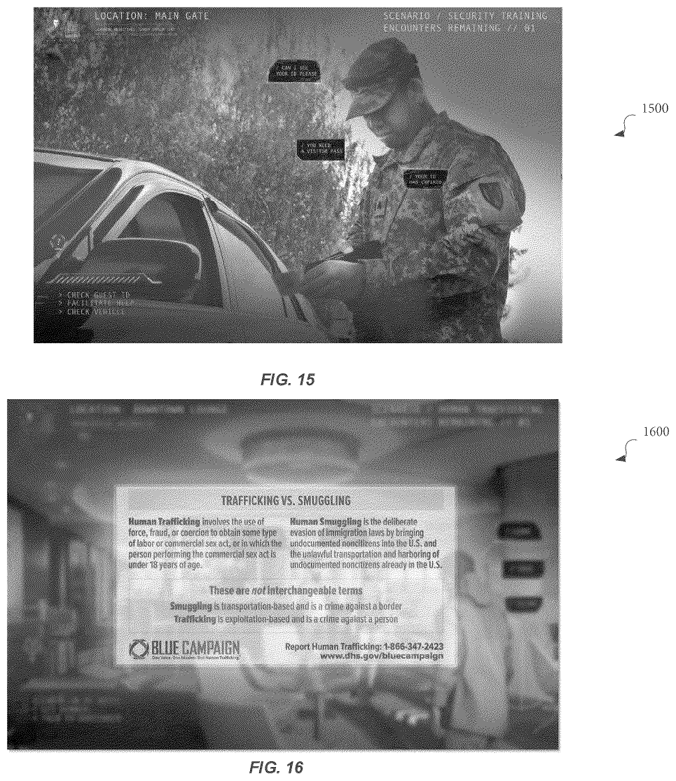

FIG. 15 illustrates another example user interface 1500 for a scenario or interactive experience for a student, according to certain embodiments of this disclosure. As depicted in FIG. 15, the user interface 1500 presents a scenario related to “Security Training” at a main gate of a military base. The student is instructed to complete the following goals: check a guest's identification, facilitate help, and check a vehicle. As further depicted in FIG. 15, the student encounters an AI-enabled character who is a motorist entering a main gate of a military base. The student can either select to ask for the motorist's identification, inform the motorist that a visitor pass is needed, or indicate that the motorist's identification has expired.

FIG. 16 illustrates another example user interface 1600 for a scenario or interactive experience for a student, according to certain embodiments of this disclosure. As depicted in FIG. 16, the user interface 1600 presents the differences between human trafficking and human smuggling. The student may be tested in a scenario on identifying when human trafficking versus human smuggling has occurred.

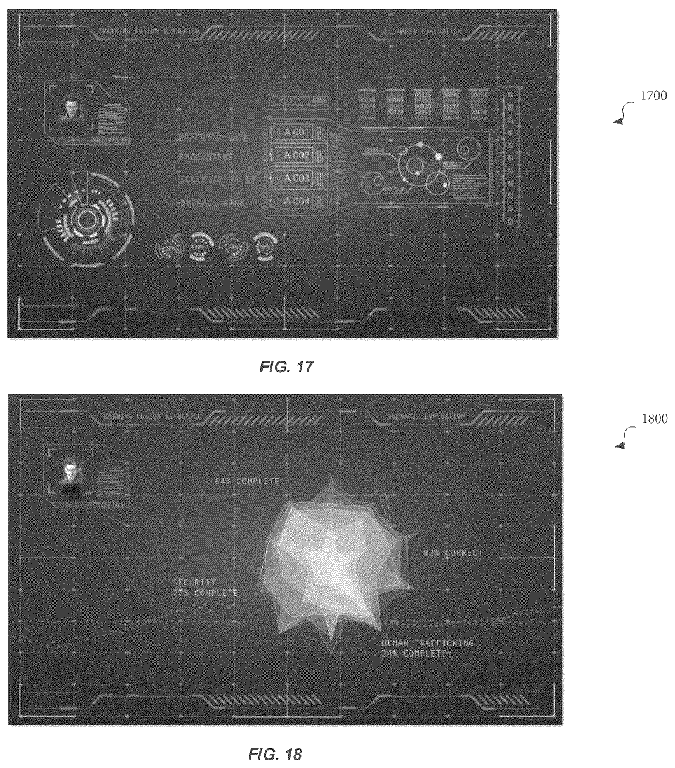

FIG. 17 illustrates another example user interface 1700 for a scenario or interactive experience for a student, according to certain embodiments of this disclosure. As depicted in FIG. 17, user interface 1700 may display graphical representations of the performance of a scenario of the student. In some embodiments, each student's performance may be scored and tracked. For example, as shown in FIG. 17, user interface 1700 displays a student's response time, number of encounters, security ratio, and overall rank.

FIG. 18 illustrates another example user interface 1800 for a scenario or interactive experience for a student, according to certain embodiments of this disclosure. As depicted in FIG. 18, user interface 1800 may display graphical representations of the performance of a scenario of the student. For example, as shown in FIG. 18, user interface 1800 displays the percentage of completion of a scenario and a percentage of correct responses of one or more scenarios.

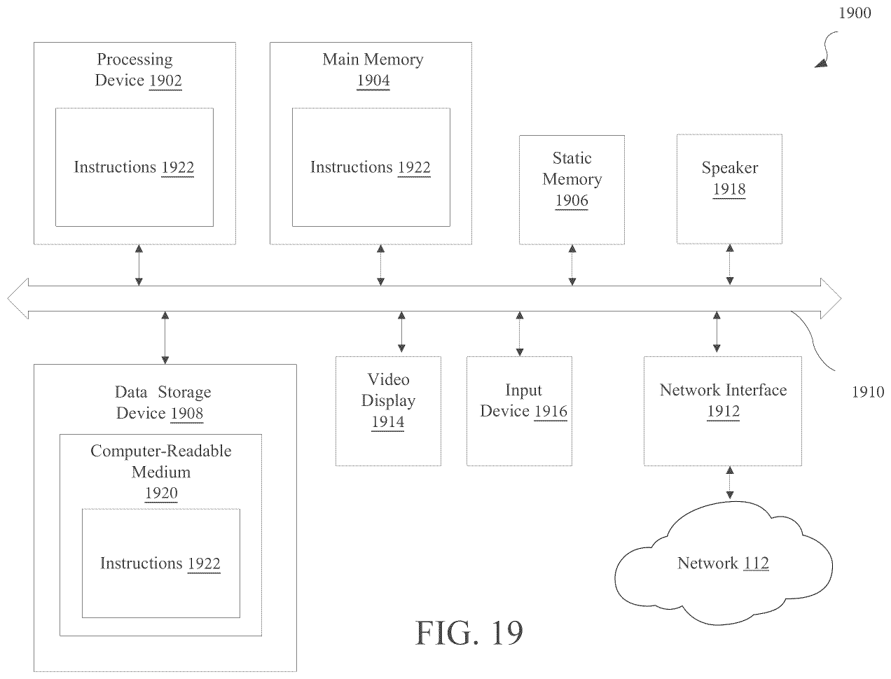

FIG. 19 illustrates an example computer system 1900 that can perform any one or more of the methods described herein. In one example, computer system 1900 may correspond to the computing device 102 or the one or more servers 128 of the cloud-based computing system 116 of FIG. 1. The computer system 1900 may be capable of executing the application 107 (e.g., scenario exercise platform) of FIG. 1. The computer system 1900 may be connected (e.g., networked) to other computer systems in a LAN, an intranet, an extranet, or the Internet. The computer system 1900 may operate in the capacity of a server in a client-server network environment. The computer system 1900 may be a personal computer (PC), a tablet computer, a laptop, a wearable (e.g., wristband), a set-top box (STB), a personal Digital Assistant (PDA), a smartphone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The computer system 1900 includes a processing device 1902, a main memory 1904 (e.g., read-only memory (ROM), solid state drive (SSD), flash memory, dynamic random-access memory (DRAM) such as synchronous DRAM (SDRAM)), a static memory 1906 (e.g., solid state drive (SSD), flash memory, static random-access memory (SRAM)), and a data storage device 1908, which communicate between one other via a bus 1910.

Processing device 1902 represents one or more general-purpose processing devices such as a microprocessor, central processing unit, or the like. More particularly, the processing device 1902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1902 may also be one or more special-purpose processing devices such as an application specific integrated circuit (ASIC), a field programmable gate array (FPGA), a digital signal processor (DSP), network processor, or the like. The processing device 1902 is configured to execute instructions for performing any of the operations and steps discussed herein.

The computer system 1900 may further include a network interface device 1912. The computer system 1900 also may include a video display 1914 (e.g., a liquid crystal display (LCD) or a cathode ray tube (CRT)), one or more input devices 1916 (e.g., a keyboard and/or a mouse), and one or more speakers 1918 (e.g., a speaker). In one illustrative example, the video display 1914 and the input device(s) 1916 may be combined into a single component or device (e.g., an LCD touch screen).

The data storage device 1916 may include a computer-readable medium 1920 on which instructions 1922 (e.g., implementing the application 107, and/or any component depicted in the FIGURES and described herein) embodying any one or more of the methodologies or functions described herein are stored. The instructions 1922 may also reside, completely or at least partially, within the main memory 1904 and/or within the processing device 1902 during execution thereof by the computer system 1900. In this regard, the main memory 1904 and the processing device 1902 also constitute computer-readable media. The instructions 1922 may further be transmitted or received over a network via the network interface device 1912.

While the computer-readable storage medium 1920 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding, or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

A method, comprises: providing a first user interface to display on a first computing device of a first user, the first user interface presenting a plurality of disparate training topics, each training topic of the plurality of disparate training topics associated with one or more learning objectives; receiving, from the first computing device, a selection of training topics from the plurality of disparate training topics; generating, based on the selection of training topics, an interactive experience for a second user to assess an understanding by the second user of one or more learning objectives associated with the selection of training topics, the interactive experience including a virtual 3D environment and one or more AI-enabled characters; and controlling visual content associated with the interactive experience being rendered on a display of a second computing device of the second user by rendering a representation of the virtual 3D environment and the one or more AI-enabled characters.

The foregoing method further comprises: receiving, from the second computing device, an interaction of the second user with the virtual 3D environment or the one or more AI-enabled characters; and adapting the visual content associated with the interactive experience based on the interaction of the second user.

The foregoing method further comprises: determining, based on interactions of the second user with the virtual 3D environment or the one or more AI-enabled characters, if the second user has attained a satisfactory understanding of the one or more learning objectives associated with the selection of training topics.

The foregoing method further comprises: providing a second user interface to display on the first computing device, the second user interface presenting the one or more learning objectives associated with the selection of training topic and corresponding scores indicating a proficiency of understanding of the second user.

The foregoing method further comprises: in response to determining that the second user has not attained the satisfactory understanding of the one or more learning objectives associated with the selection of training topics, providing a second user interface to display on the first computing device, the second user interface enabling the first user to adapt the interactive experience to further assess the understanding by the second user of the one or more learning objectives associated with the selection of training topics.

The foregoing method further comprises: in response to determining that the second user has not attained the satisfactory understanding of the one or more learning objectives associated with the selection of training topics, providing a second user interface to display on the second computing device, the second user interface indicating interactions of the second user with the virtual 3D environment or the one or more AI-enabled characters that exhibited that the second user has not attained the satisfactory understanding and alternative interactions that the second user could have had with the virtual 3D environment or the one or more AI-enabled characters that would have better indicated the understanding of the one or more learning objectives associated with the selection of training topics.

The foregoing method further comprises: tracking interactions with the interactive experience of a plurality of users; and determining, based on the interactions, an efficacy of the interactive experience to assess respective understandings of the plurality of users of the one or more learning objectives of each training topic of the plurality of disparate training topics.

The foregoing method further comprises: receiving, from a sensor, one or more measurements pertaining to the second user, wherein the one or more measurements are received during the interactive experience, and the one or more measurements indicate a characteristic of the second user; and based on the characteristic, modifying the visual content associated with the interactive experience being rendered on the display of the second computing device.

The foregoing method, wherein the sensor is a wearable device, a camera, a device located proximate the second user, a device included in the second computing device, or some combination thereof.

The foregoing method, wherein the characteristic comprises a vital sign, a physiological state, a heartrate, a blood pressure, a pulse, a temperature, a perspiration rate, or some combination thereof.

A tangible, non-transitory computer-readable medium storing instructions that, when executed, cause a processing device to: provide a first user interface to display on a first computing device of a first user, the first user interface presenting a plurality of disparate training topics, each training topic of the plurality of disparate training topics associated with one or more learning objectives; receive, from the first computing device, a selection of training topics from the plurality of disparate training topics; generate, based on the selection of training topics, an interactive experience for a second user to assess an understanding by the second user of one or more learning objectives associated with the selection of training topics, the interactive experience including a virtual 3D environment and one or more AI-enabled characters; and control visual content associated with the interactive experience being rendered on a display of a second computing device of the second user by rendering a representation of the virtual 3D environment and the one or more AI-enabled characters.

The foregoing computer-readable medium, wherein the processing device is further caused to: receive, from the second computing device, an interaction of the second user with the virtual 3D environment or the one or more AI-enabled characters; and adapt the visual content associated with the interactive experience based on the interaction of the second user.

The foregoing computer-readable medium, wherein the processing device is further caused to: determine, based on interactions of the second user with the virtual 3D environment or the one or more AI-enabled characters, if the second user has attained a satisfactory understanding of the one or more learning objectives associated with the selection of training topics.

The foregoing computer-readable medium, wherein the processing device is further caused to: provide a second user interface to display on the first computing device, the second user interface presenting the one or more learning objectives associated with the selection of training topic and corresponding scores indicating a proficiency of understanding of the second user.

The foregoing computer-readable medium, wherein the processing device is further caused to: in response to determining that the second user has not attained the satisfactory understanding of the one or more learning objectives associated with the selection of training topics, provide a second user interface to display on the first computing device, the second user interface enabling the first user to adapt the interactive experience to further assess the understanding by the second user of the one or more learning objectives associated with the selection of training topics.

The foregoing computer-readable medium, wherein the processing device is further caused to: in response to determining that the second user has not attained the satisfactory understanding of the one or more learning objectives associated with the selection of training topics, provide a second user interface to display on the second computing device, the second user interface indicating interactions of the second user with the virtual 3D environment or the one or more AI-enabled characters that exhibited that the second user has not attained the satisfactory understanding and alternative interactions that the second user could have had with the virtual 3D environment or the one or more AI-enabled characters that would have better indicated the understanding of the one or more learning objectives associated with the selection of training topics.

The foregoing computer-readable medium, wherein the processing device is further caused to: track interactions with the interactive experience of a plurality of users; and determine, based on the interactions, an efficacy of the interactive experience to assess respective understandings of the plurality of users of the one or more learning objectives of each training topic of the plurality of disparate training topics.

The foregoing computer-readable medium, wherein the processing device is further caused to: receive, from a sensor, one or more measurements pertaining to the second user, wherein the one or more measurements are received during the interactive experience, and the one or more measurements indicate a characteristic of the second user; and based on the characteristic, modify the visual content associated with the interactive experience being rendered on the display of the second computing device.

The foregoing computer-readable medium, wherein the sensor is a wearable device, a camera, a device located proximate the second user, a device included in the second computing device, or some combination thereof.

A system comprising: a memory device storing instructions; and a processing device communicatively coupled to the memory device, wherein the processing device executes the instructions to: provide a first user interface to display on a first computing device of a first user, the first user interface presenting a plurality of disparate training topics, each training topic of the plurality of disparate training topics associated with one or more learning objectives; receive, from the first computing device, a selection of training topics from the plurality of disparate training topics; generate, based on the selection of training topics, an interactive experience for a second user to assess an understanding by the second user of one or more learning objectives associated with the selection of training topics, the interactive experience including a virtual 3D environment and one or more AI-enabled characters; and control visual content associated with the interactive experience being rendered on a display of a second computing device of the second user by rendering a representation of the virtual 3D environment and the one or more AI-enabled characters.

The various aspects, embodiments, implementations or features of the described embodiments can be used separately or in any combination. The embodiments disclosed herein are modular in nature and can be used in conjunction with or coupled to other embodiments, including both statically-based and dynamically-based equipment. In addition, the embodiments disclosed herein can employ selected equipment such that they can identify individual users and auto-calibrate threshold multiple-of-body-weight targets, as well as other individualized parameters, for individual users.

1. A method, comprising:
providing a first user interface to display on a first computing device of a first user, the first user interface presenting a plurality of disparate training topics, each training topic of the plurality of disparate training topics associated with one or more learning objectives;
receiving, from the first computing device, a selection of training topics from the plurality of disparate training topics;
generating, based on the selection of training topics, an interactive experience for a second user to assess an understanding by the second user of one or more learning objectives associated with the selection of training topics, the interactive experience including a virtual 3D environment and one or more AI-enabled characters; and
controlling visual content associated with the interactive experience being rendered on a display of a second computing device of the second user by rendering a representation of the virtual 3D environment and the one or more AI-enabled characters.

2. The method of claim 1, further comprising:
receiving, from the second computing device, an interaction of the second user with the virtual 3D environment or the one or more AI-enabled characters; and
adapting the visual content associated with the interactive experience based on the interaction of the second user.

3. The method of claim 1, further comprising:
determining, based on interactions of the second user with the virtual 3D environment or the one or more AI-enabled characters, if the second user has attained a satisfactory understanding of the one or more learning objectives associated with the selection of training topics.

4. The method of claim 3, further comprising:
providing a second user interface to display on the first computing device, the second user interface presenting the one or more learning objectives associated with the selection of training topic and corresponding scores indicating a proficiency of understanding of the second user.

5. The method of claim 3, further comprising:
in response to determining that the second user has not attained the satisfactory understanding of the one or more learning objectives associated with the selection of training topics, providing a second user interface to display on the first computing device, the second user interface enabling the first user to adapt the interactive experience to further assess the understanding by the second user of the one or more learning objectives associated with the selection of training topics.

6. The method of claim 3, further comprising:
in response to determining that the second user has not attained the satisfactory understanding of the one or more learning objectives associated with the selection of training topics, providing a second user interface to display on the second computing device, the second user interface indicating interactions of the second user with the virtual 3D environment or the one or more AI-enabled characters that exhibited that the second user has not attained the satisfactory understanding and alternative interactions that the second user could have had with the virtual 3D environment or the one or more AI-enabled characters that would have better indicated the understanding of the one or more learning objectives associated with the selection of training topics.

7. The method of claim 1, further comprising:
tracking interactions with the interactive experience of a plurality of users; and
determining, based on the interactions, an efficacy of the interactive experience to assess respective understandings of the plurality of users of the one or more learning objectives of each training topic of the plurality of disparate training topics.

8. The method of claim 1, further comprising:
receiving, from a sensor, one or more measurements pertaining to the second user, wherein the one or more measurements are received during the interactive experience, and the one or more measurements indicate a characteristic of the second user; and
based on the characteristic, modifying the visual content associated with the interactive experience being rendered on the display of the second computing device.

9. The method of claim 8, wherein the sensor is a wearable device, a camera, a first device located proximate the second user, a second device included in the second computing device, or some combination thereof.

10. The method of claim 8, wherein the characteristic comprises a vital sign, a physiological state, a heartrate, a blood pressure, a pulse, a temperature, a perspiration rate, or some combination thereof.

11. A tangible, non-transitory computer-readable medium storing instructions that, when executed, cause a processing device to:
provide a first user interface to display on a first computing device of a first user, the first user interface presenting a plurality of disparate training topics, each training topic of the plurality of disparate training topics associated with one or more learning objectives;
receive, from the first computing device, a selection of training topics from the plurality of disparate training topics;
generate, based on the selection of training topics, an interactive experience for a second user to assess an understanding by the second user of one or more learning objectives associated with the selection of training topics, the interactive experience including a virtual 3D environment and one or more AI-enabled characters; and
control visual content associated with the interactive experience being rendered on a display of a second computing device of the second user by rendering a representation of the virtual 3D environment and the one or more AI-enabled characters.

12. The computer-readable medium of claim 11, wherein the processing device is further caused to:
receive, from the second computing device, an interaction of the second user with the virtual 3D environment or the one or more AI-enabled characters; and
adapt the visual content associated with the interactive experience based on the interaction of the second user.

13. The computer-readable medium of claim 11, wherein the processing device is further caused to:
determine, based on interactions of the second user with the virtual 3D environment or the one or more AI-enabled characters, if the second user has attained a satisfactory understanding of the one or more learning objectives associated with the selection of training topics.

14. The computer-readable medium of claim 13, wherein the processing device is further caused to:
provide a second user interface to display on the first computing device, the second user interface presenting the one or more learning objectives associated with the selection of training topic and corresponding scores indicating a proficiency of understanding of the second user.

15. The computer-readable medium of claim 13, wherein the processing device is further caused to:
in response to determining that the second user has not attained the satisfactory understanding of the one or more learning objectives associated with the selection of training topics, provide a second user interface to display on the first computing device, the second user interface enabling the first user to adapt the interactive experience to further assess the understanding by the second user of the one or more learning objectives associated with the selection of training topics.

16. The computer-readable medium of claim 13, wherein the processing device is further caused to:
in response to determining that the second user has not attained the satisfactory understanding of the one or more learning objectives associated with the selection of training topics, provide a second user interface to display on the second computing device, the second user interface indicating interactions of the second user with the virtual 3D environment or the one or more AI-enabled characters that exhibited that the second user has not attained the satisfactory understanding and alternative interactions that the second user could have had with the virtual 3D environment or the one or more AI-enabled characters that would have better indicated the understanding of the one or more learning objectives associated with the selection of training topics.

17. The computer-readable medium of claim 11, wherein the processing device is further caused to:
track interactions with the interactive experience of a plurality of users; and
determine, based on the interactions, an efficacy of the interactive experience to assess respective understandings of the plurality of users of the one or more learning objectives of each training topic of the plurality of disparate training topics.

18. The computer-readable medium of claim 11, wherein the processing device is further caused to:
receive, from a sensor, one or more measurements pertaining to the second user, wherein the one or more measurements are received during the interactive experience, and the one or more measurements indicate a characteristic of the second user; and
based on the characteristic, modify the visual content associated with the interactive experience being rendered on the display of the second computing device.

19. The computer-readable medium of claim 18, wherein the sensor is a wearable device, a camera, a first device located proximate the second user, a second device included in the second computing device, or some combination thereof.

20. A system comprising:
a memory device storing instructions; and
a processing device communicatively coupled to the memory device, wherein the processing device executes the instructions to:
provide a first user interface to display on a first computing device of a first user, the first user interface presenting a plurality of disparate training topics, each training topic of the plurality of disparate training topics associated with one or more learning objectives;
receive, from the first computing device, a selection of training topics from the plurality of disparate training topics;
generate, based on the selection of training topics, an interactive experience for a second user to assess an understanding by the second user of one or more learning objectives associated with the selection of training topics, the interactive experience including a virtual 3D environment and one or more AI-enabled characters; and
control visual content associated with the interactive experience being rendered on a display of a second computing device of the second user by rendering a representation of the virtual 3D environment and the one or more AI-enabled characters.
